(19) United States
(12) Patent Application Publication
(10) Pub. No.: US 2023/0018335 A1
(43) Pub. Date: Jan. 19, 2023

(54) MACHINING SYSTEM

(71) Applicant: Festo SE & Co. KG, Esslingen (DE)

(72) Inventor: Ralf Riemensperger, Esslingen (DE)

(21) Appl. No.: 17/866,801

(22) Filed: Jul. 18, 2022

(30) Foreign Application Priority Data
Jul. 19, 2021 (DE) 10 2021 207 664.5

(51) Int. Cl. B23Q 7/04

(52) U.S. Cl. CPC B23Q 7/048

(57) ABSTRACT

Machining system for machining workpieces, having a transport module which includes a transporter for transporting workpiece carriers along a transport path and a plurality of coupling areas, and having at least one process module, which includes a processing system for processing workpieces, a transport system for transporting workpiece carriers between the transport path and a processing position assigned to the processing system, and a coupling system for coupling to the transport module, the transport module including at least one manipulator from the group: stop device for temporarily stopping a workpiece carrier, deflection device for deflecting the direction of a workpiece carrier, and wherein the process module provides a control signal to the at least one manipulator of the transport module.

### BACKGROUND OF THE INVENTION

The invention relates to a machining system for machining workpieces and is designed for flexible adaptation to different production requirements by means of a modular structure in which transport modules and process modules are provided.

### SUMMARY OF THE INVENTION

The task of the invention is to provide a machining system in which an addition and/or removal of one or more process modules can also be carried out during a productive phase of the machining system.

This task is solved for a machining system of the type mentioned at the beginning with the following features: the machining system comprises a transport module with a transporter for transporting workpiece carriers along a circular transport path and further comprises a plurality of coupling areas, each of the coupling areas being designed for coupling a process module, at least one process module is provided, which comprises a processing system for workpiece processing, a transport system for transporting workpiece carriers between the transport path and a processing position assigned to the processing system, and a coupling system for coupling to the transport module, wherein at least one manipulator from the group of: Stop system for temporarily stopping a workpiece carrier, Deflection system for deflecting the direction of a workpiece carrier is provided on the transport module, and wherein the process module is designed to provide a control signal to the at least one manipulator of the transport module.

The task of the transport module is to provide a circulating movement for a certain number of workpiece carriers, which may in particular be workpiece trays. This circulating movement takes place along a circulating transport path, wherein the transport path can be annular, for example with a substantially rectangular course. Preferably, it is provided that the workpiece carriers have an at least substantially constant transport speed along the transport path. Preferably, it is provided that the transporter of the transport module does not provide for individual consideration of properties of individual workpiece carriers, but rather transports all workpiece carriers in the same manner along the transport path.

The transport module comprises several coupling areas, whereby a process module can be coupled to each of the coupling areas. A process module is designed to transport workpiece carriers with workpieces mounted on them from the transport path to a processing position using a transport system assigned to the process module and to perform processing of the workpiece mounted on the workpiece carrier there using a processing system. Subsequently, the workpiece carrier with the workpiece mounted on it is returned to the transport path, whereby no consideration is given to the sequence of the workpiece carriers mounted on the transport path. Rather, it is merely provided that the process module transports from the transport path to the processing position only those workpiece carriers with the workpieces accommodated thereon which, when passing the respective process module, are to be machined with that machining process which can be carried out in the respective process module with the aid of the processing system. The processing system can be, purely by way of example, an assembly device, a testing device, an inspection device or a labelling device.

To enable easy attachment and removal of a process module to the transport module, the transport module has the coupling areas. Each of the process modules has a coupling system adapted to the coupling areas, in particular to ensure an advantageous electrical and mechanical connection between the process module and the transport module. In the case of a coupling of the process module to the transport module, it is further provided that the process module can influence at least one manipulator from the group: stop system, deflection system, located on the transport module in the area of the respective coupling area, with the aid of a corresponding control signal. Through this, a workpiece carrier transported along the transport path can be stopped and/or deflected in the direction of the processing position in the process module, provided that the workpiece carrier is provided with a workpiece which is to be fed to the processing system provided in the process module.

The control signal which can be provided by the process module is preferably an electrical signal which is transmitted to the at least one manipulator which is located on the transport module in the respective coupling area. Alternatively, the control signal can also be a fluidic, in particular hydraulic or pneumatic, signal or a mechanical actuating movement of an actuator associated with the process module. It is decisive that the process module can be used to influence a functional position of the at least one manipulator.

Accordingly, only the process module is responsible for redirecting a workpiece carrier with a workpiece picked up thereon to its own processing position, if required. The transport module does not need to have knowledge of the extent to which a coupled process module is ready to receive a workpiece carrier with a workpiece received thereon at a given time, or whether this is not the case. This means that a control system for the transport module can be kept very simple, since the sole task of the transport module is to keep the workpiece carriers in circulation along the transport path. All other functions for handling the workpiece carriers are performed by the process modules and therefore do not require any complex communication between the transport module and the respective process modules.

Advantageous further embodiments of the invention are the subject of the subclaims.

It is expedient if the transporter comprises at least one conveyor device from the group: belt conveyor, chain conveyor, wheel conveyor, magnetic conveyor, fluid conveyor, linear motor, and/or that the transporter is designed for providing a continuous conveying movement. The transporter may comprise exactly one conveyor device or several conveyor devices of the same type. Alternatively, it is provided that the transporter comprises differently designed conveyor devices, for example in order to be able to meet different transport requirements for the workpiece carriers to be transported. In this case, belt conveyors, chain conveyors and wheel conveyors are designed for preferably frictional coupling with a workpiece carrier to be transported. In the case of a magnetic conveyor, exemplary provision can be made to fix a permanent magnet to an actuator and to effect a relative movement of the workpiece carrier along the transport path by magnetic interaction with a workpiece carrier designed to conduct magnetic flux. In the case of a fluid conveyor, exemplary provision is made for propelling the workpiece carrier with the aid of a jet of compressed air and/or deflecting it in the direction of a movement path. In an embodiment of the conveyor device as a linear motor, it can be provided by way of example that the conveyor device forms a linear motor stator, while the workpiece carrier forms a linear motor rotor and a relative movement of the workpiece carrier along the transport path is effected by an electrically predetermined travelling magnetic field. Preferably, the transporter is designed to provide a continuous conveying movement, which, however, does not exclude the occurrence of areas along the transport path with different conveying speeds for the workpiece carriers. On the other hand, it is not intended to accelerate or decelerate individual workpiece carriers individually by means of the at least one conveyor device.

Preferably, it is provided that the process module comprises a process control which is designed to control a machining process in the process module and to provide a control signal to the manipulator. Exemplarily, the process control is a programmable logic controller that is designed in particular for autonomous operation of the process module without a need for communication with a higher-level control system or the transport module. By way of example, the process control comprises one or more software modules, with the aid of which, on the one hand, the machining process can be carried out in the respective process module and, on the other hand, which are set up for the performance of the transport tasks by the transport system of the process module. In addition, the process control is designed for providing at least one control signal to the at least one manipulator which is arranged on the transport module in the region of the process module and with the aid of which workpiece carriers moving along the transport path can be stopped and/or diverted into the process module.

In a further embodiment of the invention, it is provided that the process control is designed to process a sensor signal of a sensor device, in particular arranged on the transport module, the sensor device being designed to detect workpiece carrier information of a workpiece carrier. By way of example, it can be provided that the workpiece carrier information enables unambiguous identification of the workpiece carrier and that the process control is connected to an external database, which can also be a data cloud. The database stores all the information that the process control requires for processing the workpiece mounted on the workpiece carrier. Alternatively, it may be provided that the workpiece carrier information includes all information required by the process module for processing the workpiece mounted on the workpiece carrier, so that no contact of the process control to an external database is required. In any case, scanning the workpiece carrier with the aid of the sensor device provides information or a group of information to the process control indicating the manner in which further processing of the workpiece mounted on the workpiece carrier is to be carried out.

It is advantageous if the process module has a module housing to which a safety control and at least one safety sensor from the group: light barrier, light curtain, door contact switch, are assigned. The safety control is designed for processing a sensor signal of the safety sensor and for a safety-related shutdown of a machining process and/or a transport process for a workpiece carrier in the process module. In addition or alternatively, a lock or a pass-through tunnel are assigned to the coupling system. The module housing can be provided in different sizes, in particular following a predeterminable grid dimension, in order to ensure advantageous integration of a machining process and the components required for this in a suitable module housing. The module housing, which can in particular be a standardized to assembly, also ensures that the machining process running in the process module always satisfies the safety requirements on which the machining system is based. This requirement is met by the safety control, which monitors as a minimum requirement that there is no unauthorized intervention by a user in a working area enclosed by the module housing. For this purpose, the safety control comprises at least one safety sensor with which penetration of objects and/or body parts into the module housing can be monitored in order to ensure immediate safety-related shutdown of the machining process and/or transport process for a workpiece carrier taking place in the module housing. It is particularly advantageous if the safety control can directly access the energy flows provided by the process control of the process module to the processing system and interrupt them in a safety-oriented manner. In particular, the safety control is designed as a component of the process control.

In addition or alternatively, it is provided that a lock or a reach-through tunnel is arranged at the coupling system of the process module, which prevents a user from accessing the space volume limited by the module housing and qualifying as a hazardous area. The aforementioned measures always ensure that the process module fulfils a predefinable safety level within predefinable safety regulations. Thus, regardless of a commissioning or decommissioning of the respective process module, the overall safety of the processing system is always maintained without the need for a reassessment of the safety level to be maintained.

In a further embodiment of the invention, it is provided that the transport module comprises a first coupling part for a positive mechanical coupling with the process module and a first plug arrangement for an electrical coupling with the process module, and that the coupling system of the process module comprises a second coupling part for a positive mechanical coupling with the first coupling part and a second plug arrangement for an electrical coupling with the first plug arrangement. In this case, the first coupling part and the second coupling part ensure a dimensionally stable connection between the transport module and the process module. A reliable fixed connection between the transport module and the process module is ensured, particularly with regard to machining operations that are carried out in the process module and during which acceleration forces can be exerted on the process module by rapid movements of an industrial robot, for example. For coupling the process module to the transport module, it must be taken into account that the ground on which the transport module and the process module are placed is not necessarily level. Thus, the coupling formed by the first coupling part and the second coupling part must be able to compensate for such different orientations of the transport module and the process module. The first coupling arrangement and the second coupling arrangement can be used to provide a direct electromechanical connection between the transport module and the process module when performing a coupling operation or a decoupling operation, respectively, between the process module and the transport module. Preferably, it is provided that the first plug arrangement is attached to a flexible cable section extending from the transport module and that the first plug arrangement can be manually plugged by an operator into a second plug arrangement fixedly attached to the process module. This avoids a static overdetermination for a mechanical coupling between the transport module and the process module.

In an advantageous further embodiment of the invention, it is provided that each of the first plug arrangements is electrically connected to a manipulator or to a manipulator and a sensor. This enables provision of a control signal from the process module to the manipulator via the second plug arrangement. Preferably, the electrical communication between the process module and the transport module is limited solely to the provision of control signals from the process module to the manipulator associated with the transport module. In a further embodiment of the invention, additional signal transmission may be provided between a sensor associated with the transport module and the process module. Furthermore, an electrical supply connection may be provided between the transport module and the process module, whereby no information or sensor signals are transmitted via this electrical supply connection.

It is expedient if the process module comprises feet that can be adjusted in height in an automated manner, as well as a position sensor and a control system, which are designed for an adjusting movement of the feet for the automatic execution of a coupling process with the respective coupling area and for an automatic spatial alignment of the process module with respect to the transport module. For example, the automatically height-adjustable feet can be designed as electric linear actuators with a geared motor and a threaded spindle. Thus, by providing electrical energy, a relative movement between the threaded spindle and the electric motor can be realized in order to realize an extending movement or a retracting movement for the respective stand foot. Alternatively, the automatically height-adjustable stand feet can be designed to be hydraulically or pneumatically adjustable. The control system, which is designed in particular as a component of the control system, is used to carry out a targeted control of the feet that can be adjusted in height in an automated manner, in which case the control system accesses signals from a position sensor. This allows to select an alignment of the process module on the basis of the sensor signals from the position sensor in such a way that an advantageous transition between the process module and the transport module is ensured. This is particularly the case if a largest surface of the process module, which can also be referred to as a transport surface and a working surface of the process module, is arranged in the same plane as a transport plane of the transport module. By way of example, it can be provided that, for carrying out a coupling process with the transport module, the process module is first brought by an operator, in particular using a lifting carriage, into a position relative to the transport module, from which a reliable coupling between the process module and the transport module can be ensured.

Subsequently, after the electrical connection between the transport module and the process module has been established, an electrical supply to the process module is made possible by plugging the first plug arrangement into the second plug arrangement. In a subsequent step, by way of example, a lowering of those feet of the process module which are arranged adjacent to the transport module can be carried out in order to thereby cause the second coupling part to engage with the first coupling part. In a subsequent step, the sensor signal of the position sensor can be used by the control system to control the feet of the process module that are arranged at a distance from the transport module in order to set the desired advantageous spatial alignment of the process module relative to the transport module.

Preferably, it is provided that the transport module comprises a base module on which two first transport path sections aligned parallel to one another are formed, and that first connection areas are formed on opposing end faces of the base module, each of which is designed for connection to a further base module or to a deflection module. This enables flexible use of the transport module in a scalable machining system, since optionally several transport modules can be connected directly to one another or a deflection module can be attached to the end of a transport module, with the aid of which the desired deflection operation for the workpiece carriers to be transported in the machining system can be realized between the two first transport path sections. Preferably, the first connection areas of the transport module are designed for both a mechanical and an electrical connection with adjacent base modules or deflection modules, so that no additional cabling is required between the base module and an adjacent base module or deflection module.

Preferably, it is provided that the transport module comprises at least one deflection module on which a second transport path section aligned transversely to the first transport path sections is formed, and that a second connection area is formed on a side surface of the deflection module, which second connection area is designed for connection to the first connection area of the base module. The task of the deflection module is to connect the two first transport path sections formed on the basic module, which are each controlled for a movement of the workpiece carrier in mutually opposite directions. For this purpose, the deflection module comprises the second transport path section, which is formed transversely to the first transport path section and enables the desired circulation movement at the end of the transport module for the respective workpiece carrier. The second connection section of the deflection module is adapted to the first connection section of the base module and enables a simple mechanical and electrical connection between the base module and the deflection module.

Preferably, it is provided that a storage module is arranged at a coupling area of the transport module, comprising a plurality of conveyors selected from the group consisting of: belt conveyors, chain conveyors, wheel conveyors, magnetic conveyors, fluid conveyors, linear motors, which conveyors are controllable independently of each other, and that the storage module is designed for temporary intermediate storage and/or for changing a sequence of workpiece carriers accommodated on the transport path. The basic principle of the processing system is that the workpiece carriers are kept in circulation on the transport module until they have completed all the processing steps provided for them by the processing modules associated with the transport module. Due to the flexible determination of the transport path for the individual workpiece carrier, which transport path is determined, in particular exclusively, by the individual process modules, it is not necessary to control the transport module. However, in the event of a malfunction at a process module, the case can arise that, for example, two groups of workpiece carriers, which are equipped with different workpieces and which are moved on the transport path of the transport module, interfere with each other. For example, a first group of workpieces can still be processed, while a second group of workpieces cannot be processed at first due to the possibly failed process module. To enable simple further processing of the first group of workpieces for such a situation, provision can be made with the aid of the storage module to remove the workpiece carriers with the second group of workpieces from the transport path and to temporarily accommodate them until the problem with the respective process module has been rectified. In addition or alternatively, the storage module can also be used for overtaking operations in which a sequence of the workpiece carriers received on the transport path of the transport module is to be changed in order to enable advantageous processing of the individual workpieces received on the workpiece carriers. For example this may be the case if a workpiece carrier with a workpiece held on it is to be processed by a process module arranged downstream of the storage module on the transport path, but this process module has not yet completely finished a previous processing operation and a further circulation of the workpiece carrier that has not yet been processed would cause a time delay. In this case, a temporary intermediate storage of the respective workpiece carrier in the storage module can be carried out, while other workpiece carriers with workpieces that have to arrive at other process modules can pass through the storage module or overtake the first workpiece carrier within the storage module.

### BRIEF DESCRIPTION OF THE DRAWINGS

An advantageous embodiment of the invention is shown in the drawing. Here shows:

FIG. 1 a strictly schematic top view of a machining system with a transport module, two process modules ready for operation, a process module intended for coupling, and a storage module,

FIG. 2 a strictly schematic representation of the electrical connections in the processing system according to FIG. 1,

FIG. 3 a side view of one of the process modules according to FIG. 1,

FIG. 4 a side view of a base module of the transport module shown in FIG. 1, and

FIG. 5 a front view of the basic module according to FIG. 4.

### DETAILED DESCRIPTION

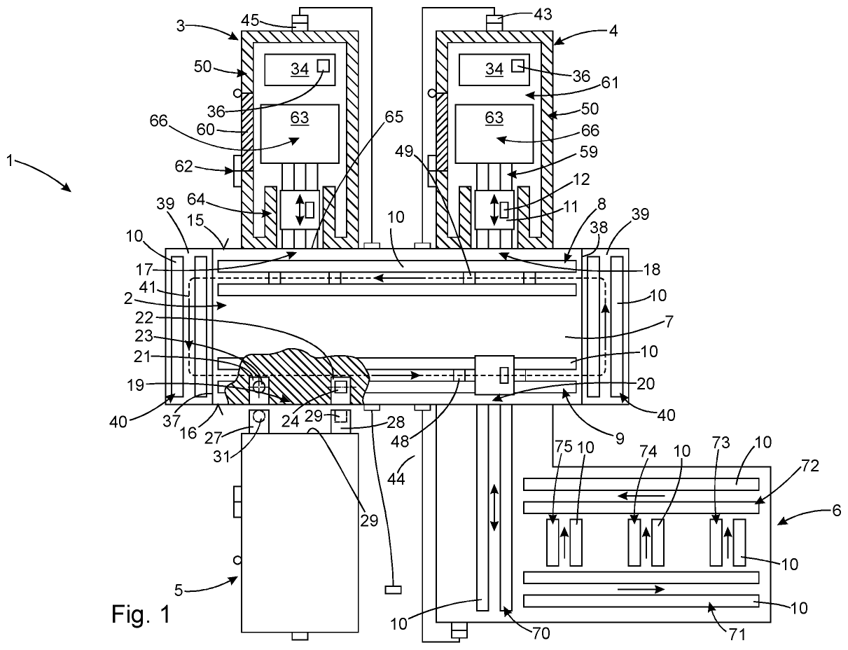

A processing system 1 shown in FIG. 1 by way of example only comprises a transport module 2 to which a first process module 3, a second process module 4 and a storage module 6 are coupled. Furthermore, a third process module 5 is prepared for coupling to the transport module 2.

The transport module 2 comprises a base module 7 with an exemplary rectangular base area, on which two first transport path sections 8 and 9 are formed, which are aligned parallel to one another and arranged at a distance from one another. Purely by way of example, the two first transport path sections 8 and 9 are implemented as belt conveyors, each with two conveyor belts 10 running parallel to one another. According to the illustration of FIG. 1, one first transport path section 8 is provided for a transport movement from right to left, while the other first transport path section 9 is provided for a transport movement from left to right. By way of example, a workpiece carrier 11 is accommodated on the first transport path section 9, which workpiece carrier 11 is designed as a square plate and which carries an identifier 12. The identifier 12 may be, for example, an RFID tag.

Two coupling areas 17, 18, 19 and 20 are formed on mutually remote largest side surfaces 15 and 16 of the base module 7, respectively, which coupling areas 17, 18, 19 and 20 are provided in a manner described in more detail below for coupling process modules 3 to 5 or storage modules 6. As can be seen from the cut-out representation in FIG. 1 and from the representation in FIG. 5, each of the coupling areas 17 to 20 is designed as an arrangement of a first shaft 21 with a fixed bearing 23 and a second shaft 22 with a floating bearing 24. Purely by way of example the fixed bearing 23 is of a hemispherical design and is arranged on a base surface 25 of the first shaft 21.

Purely by way of example the floating bearing 24 is of semicircular-cylindrical design and is arranged on a base surface 26 of the second shaft 22. The fixed bearing 23 and the floating bearing 24 are provided for mechanical coupling with correspondingly designed bearing projections 27 and 28, which are arranged on an end face 29 of the respective process module 3 to 5. By way of example, a hemispherical recess, not shown in more detail, is provided in the bearing projection 27, which is adapted to the geometry of the fixed bearing 23. Furthermore, the bearing projection 28 is provided with a hemispherical cylindrical recess 30 which is adapted to the geometry of the floating bearing 24. When the position projections 27 and 28 are placed on the fixed bearing 23 and the floating bearing 24, a statically defined mechanical coupling between the respective process module 3 or 4 or 5 or the storage module 6 and the base module 7 of the transport module 2 is achieved.

For carrying out a coupling process between one of the process modules 3 to 5 or a storage module 6 and the base module 7, the process modules 3 to 5 and the storage module 6 are each assigned automated height-adjustable feet 33, which are designed purely exemplarily as electrical threaded spindle drives and which are connected in a manner not shown in more detail to a control system 34 or 35, which control system 34 or 35 is associated with the respective process module 3 to 5 or with the storage module 6.

The control systems 34 or 35 are assigned a position sensor 36 respectively, which position sensor 36 is designed to detect a spatial orientation of the respective process module 3 to 5 or of the storage module 6. The sensor signals of the position sensor 36 are used by the respective control system 34 or 35 for the horizontal levelling of the respective process module 3 to 5 or of the storage module 6.

In a purely exemplary manner, the transport module 2 comprises two deflection modules 39 each arranged on opposite end faces 37, 38. Each of the deflection modules 39 comprises a second transport path section 40, which can be formed in the same way or differently from the first transport path sections 8, 9 of the base module 7. Each of the second transport path sections 40 is provided for connecting the two first transport path sections 8, 9 of the basic module 7.

Purely by way of example, a design of the second transport path section 40 as a belt conveyor with two conveyor belts 10 running parallel to one another is provided for both deflection modules 39. By way of example, it is provided that the deflection modules 39 can be coupled to the basic module 7 in the same way as the process modules 3 to 5 by means of bearing projections. For this purpose, the base module 7 has coupling areas 42 with a fixed bearing 23 and a floating bearing 24 on each of its end faces 37 as shown in FIG. 4. A first plug part 85 is arranged between the fixed bearing 23 and the floating bearing 24, which can be electromechanically coupled to a second plug part 87 of the deflection module. Purely by way of example, it is provided that the two plug parts 85, 87 are movably mounted on the base module 7 or on the deflection module 39 or on the deflection module 39, in order not to hinder a relative movement between the base module 7 and the deflection module 39 during the coupling process.

The first transport path sections 8, 9 of the base module 7 and the two second transport path sections 40 of the two deflection modules 39 thus determine an essentially rectangular transport path 41, which is designed purely exemplarily for a counterclockwise circulation movement of workpiece carriers 11.

For an electrical connection of the process modules 3 to 5 and of the storage module 6 to the transport module 2, cable sections 44 are arranged on the largest side surfaces 15, 16 of the base module 7 in each case, on which first plug arrangements 43 are mounted. By way of example, it is provided that the first plug arrangements 43 are connected to second plug arrangements 45, 46 of the process modules 3 to 5 or of the storage module 6, respectively.

Exemplarily, it is provided that a latch 47 is arranged in the first shaft 21 for the fixed bearing 23, which is linearly displaceable, exemplarily in vertical direction. The latch 47 can be adjusted between a release position shown in FIGS. 4 and 5 and a locking position approximating the fixed bearing 23 by means of an adjusting device not shown in greater detail. The task of the latch 47 is to hold the bearing projection 27 of the respective process module 3 to 5 or of the storage module 6 on the fixed bearing 23.

By way of example, it is provided that each of the coupling areas 17 to 20 is assigned a sensor 48, which sensor 48 is designed for reading out the identifier 12 provided on the workpiece carrier 11. Furthermore, each of the coupling areas 17 to 20 has associated therewith a manipulator which is designed purely exemplarily as a stopper 49 and by means of which a movement of the workpiece carrier 11 travelling along the transport path 41 can be stopped. Exemplarily, the stopper 49 is designed as an electrical linear actuator, in which a plunger, which is not shown in more detail, can be moved between a retracted rest position and an extended functional position. In the functional position, further movement of a workpiece carrier 11 is prevented. Furthermore, it is provided purely exemplarily that the first transport path sections 8 and 9 as well as the second transport path sections 40 are designed for continuous movement and a stopping of workpiece carriers 11 is effected exclusively via the respective stoppers 49.

A more detailed description of the first process module 3 is given below, the second process module 4 and the third process module 5 having in principle the same structure, although different processing operations for workpieces may be implemented there.

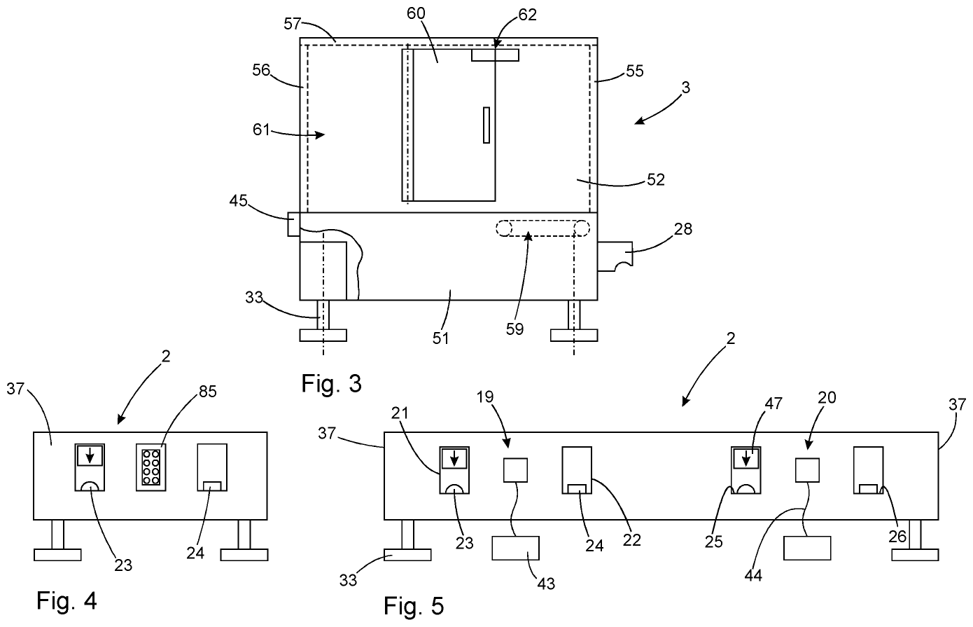

By way of example, the process module 3 comprises a module housing 50, which is constructed from a base plate 51 and a housing attachment 52 placed thereon, wherein the housing attachment comprises side walls 53, 54, 55, 56 and a cover plate 57 resting thereon. The base plate 51 accommodates the automatically adjustable feet 33. Furthermore, the two bearing projections 27 and 28 are formed on the front side 29 of the module housing 50. The second plug arrangement 45 is attached to a rear side 58 of the module housing 50. In addition, a transport system 59, designed purely exemplarily as a belt conveyor, is arranged in the base plate 51, which is indicated by a dashed line in the illustration of FIG. 3. A maintenance flap 60 is formed in the left-hand side wall 53, which can be swivelled from a closed position according to FIGS. 1 and 3 into an open position, in order to allow an operator, who is also not shown, to access to the space volume 61 enclosed by the housing attachment 52.

To protect the maintenance flap 60, a door contact switch 62 is provided, which is connected in a manner to the control system 34, which is designed at least in this respect as a safety control. Accordingly, a machining operation carried out in the chamber volume 61 is interrupted by the control system 34 if the maintenance flap 60 is opened during operation and a triggering of the door contact switch 62 occurs.

By way of example, a processing system 63 designed as a labelling unit is arranged in the space volume 61, which can be used, for example, for laser labelling of workpieces that can be conveyed on workpiece carriers 11 into the process module 3 with the aid of the transport system 59. A reach-through tunnel 64 is also formed on the front side wall 55 to protect the space volume 61, the dimensions of which are such that during operation of the process module 3 an operator cannot reach into the danger zone, which is formed for example by the processing system 63, even if he reaches into the transport opening 65 bordered by the reach-through tunnel 64.

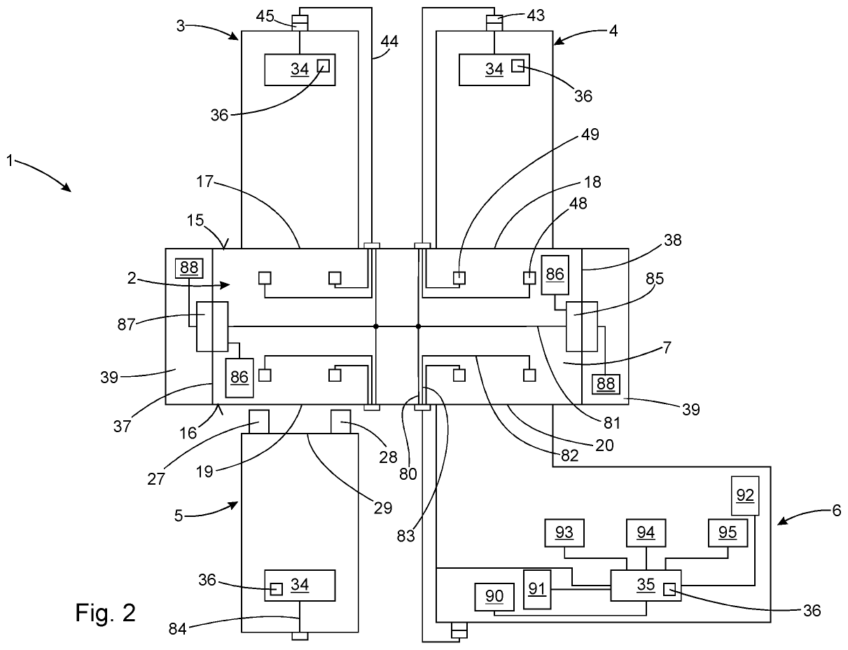

The storage module 6, also shown purely schematically in FIG. 1, comprises a plurality of transport path sections 70, 71, 72, 73, 74 and 75. Purely exemplarily, all transport path sections 70 to 75 of the storage module 6 are designed as belt conveyors with two conveyor belts 10 running parallel to each other. Furthermore, as can be seen from the representation of FIG. 2, each of the transport path sections 70 to 74 is assigned its own drive 90, 91, 92, 93, 94 and 95. Accordingly, each of the transport path sections 70 to 75 can be individually activated or deactivated to enable advantageous transport of workpiece carriers 11.

As can be further seen from the representation of FIG. 2, the drives 90 to 95 of the storage module 6 are connected to the control system 35 of the storage module 6 via unspecified control lines, which control lines are designed for selective control of the individual drives 90 to 95. For a power supply, the control system 35 is connected to the transport module 2 via the second plug arrangement 46 and the first plug arrangement 43.

Each of the first plug arrangements 43 is connected to a supply line 81 of the transport module 2 via a connecting line 80, wherein only electrical power, but no electrical signals, is provided to the respective first plug arrangements 43 via the respective supply line 81 and the respective connecting line 80. Furthermore, each of the first plug arrangements 43 is assigned a sensor line 82, which is connected to the sensor 48, so that sensor signals of the sensor 48 can be provided, in particular exclusively, to the first plug arrangement 43. In addition, the first plug arrangement 43 is assigned a control line 83 which is connected to the stopper 49. Exemplarily, the stopper 49 is designed for electrical control, so that when a control signal is fed to the first plug arrangement 43, the stopper 49 can be controlled via the control line 83.

The supply line 81 is in turn connected to first plug parts 85 arranged at the ends of the base module 7, which are arranged on the end face 37 of the base module 7 as shown in FIG. 4 and are provided for connection to a corresponding plug part 87 of the respective deflection module 39. Furthermore, the supply line 81 is in electrical connection via the plug part 85 with a drive 86, which is designed in particular as an electric motor and which is provided for providing a movement for the first transport path sections 8 and 9 of the base module 7.

As can further be seen from the schematic representation of FIG. 2, a second connector part 87 is associated with the deflection module 39, which is electrically connected to a drive 88. The drive 88 is provided for providing a movement to the second transport path section 40 of the deflection module 39 and can, in particular, be designed as an electric geared motor.

In each of the process modules 3 to 5, starting from the second plug arrangement 45, a connection line 84 is provided which connects the second plug arrangement 45 to the control system 34. Via this connection line 84, the control system 34 can, on the one hand, receive sensor signals from the sensor 48 and, after processing these sensor signals, can, if necessary, electrically control the stoppers 49 in the transport module 2.

A mode of operation of the processing system 1 can be described as follows: first, a determination is made as to the number of basic modules 7, process modules 3 to 5, storage modules 6 and deflection modules 39 required for processing a predetermined production task. Then, the basic module or modules 7 are first coupled with the deflection modules 39 to determine the respective transport path 41. Then the process modules 3 to 5 and, if necessary, one or more storage modules 6 are coupled to the basic module 7. After a start-up of the basic module or modules 7, the deflection modules 39 as well as the process modules 3 to 5 and, if necessary, the memory module 6, a placement of workpiece carriers 11 equipped with workpieces at any position on the transport path 41 is carried out. This provisioning process for the workpiece carriers 11 can be carried out, for example, with an industrial robot. All workpiece carriers 11 placed on the transport track 41 are now transported past the process modules 3 to 5 in a circulating movement. When a workpiece carrier 11 approaches a sensor 48 of a coupling area 17 to 20, the process module 3 to 5 assigned to the respective coupling area 17 to 20 and electrically connected to the sensor device or the storage module 6 can determine the identity of the respective workpiece carrier 11 by reading out, in particular contactless, the identifier 12.

By way of example, it is provided that each of the process modules 3 to 5 and the storage module 6 is connected in a manner to an external database, which in particular can be a component of a production management system. On the basis of a query of this external database, for example, one of the process modules 3 to 5 can determine whether machining of the respective workpiece received on the workpiece carrier 11 is to take place or whether this is not the case. If machining of the workpiece is to be carried out by the respective process module 3 to 5, the process module 3 to 5, which is electrically connected to the stopper 49 can output a control signal to the stopper 49 so that the latter is transferred from a rest position to a functional position in which further movement of the workpiece carrier 11 is prevented. Subsequently, the respective process module 3 to 5 activates the transport system 59 in order to transport the workpiece carrier 11 from the transport path 41 through the transport opening 65 to a processing position 66.

Purely exemplarily, the processing position 66 is arranged within the processing system 63, which is enclosed by a housing. In a subsequent step, the desired machining of the workpiece takes place in the processing system 63. The workpiece carrier is then conveyed back onto the transport path 41 by the transport system 59. Parallel to the transport of the workpiece carrier 11 from the processing position 66 to the transport path 41, it can be provided that the respective process module 3 to 5 makes a change in the machining status for the workpiece just machined in the external database. On the one hand, this ensures that the workpiece is not processed again by the corresponding process module 3 to 5. In addition, the other process modules 3 to 5, which can perform subsequent machining steps for the workpiece, can now access the workpiece held on the workpiece carrier 11.

During the period of time within which the above-described transport operation with the transport system 59 and the machining operation with the processing system 63 take place, scanning of identifier 12 and activation of the stop device 49 by the process module 3 to 5 can be dispensed with. After the workpiece carrier 11 with the processed workpiece has been conveyed back onto the transport path 41, a scanning of an identifier 12 and, if necessary, an activation of the stop device 49 by the process module 3 to 5 can be carried out again as soon as another workpiece carrier 11 arrives which is provided with a workpiece to be processed with the processing system 63.

By way of example, it can be provided that the workpiece carriers 11 are conveyed along the transport path 41 until all the machining operations provided for the respective workpiece have been carried out. As soon as this is the case, provision can be made, for example, to remove the workpiece carrier 11 with the workpiece picked up thereon from the transport path 41, in particular by means of an industrial robot.

Instead of a process module 3 to 5, the transport module 2 can also be assigned a manual workstation, which is designed in the manner of a process module 3 to 5, but instead of the processing system 63 for manual workpiece processing by an operator not shown. Such a manual workstation can, for example, be coupled to the transport module 2 in place of a failed process module 3 to 5 in the event of failure of a process module 3 to 5.

What is claimed is:

1. A machining system for machining workpieces, having a transport module which comprises a transporter for transporting workpiece carriers along a transport path and a plurality of coupling areas for coupling with respective process modules, the machining system having at least one process module which comprises a processing system for processing workpieces and a transport system for transporting workpiece carriers between the transport path and a processing position assigned to the processing system, and further comprises a coupling system for coupling to the transport module, wherein the transport module comprises at least one manipulator from the group: stopper for temporarily stopping a workpiece carrier, deflection module for deflecting a direction of a workpiece carrier, and wherein the process module provides a control signal to the at least one manipulator of the transport module.

2. The processing system according to claim 1, wherein the transporter comprises at least one conveyor from the group: belt conveyor, chain conveyor, wheel conveyor, magnetic conveyor, fluid conveyor, linear motor, and/or wherein the transporter provides a continuous conveying movement.

3. The processing system according to claim 1, wherein the process module comprises a process control for controlling a machining process in the process module and for providing a control signal to the manipulator.

4. The processing system according to claim 3, wherein the process control processes a sensor signal from a sensor which is assigned to the transport module, the sensor detecting workpiece carrier information of a workpiece carrier.

5. The processing system according to claim 1 wherein the process module has a module housing to which a safety control and at least one safety sensor from the group: light barrier, light curtain, door contact switch, are assigned, and wherein the safety control processes a sensor signal of the safety sensor for a safety-oriented shutdown of a machining process and/or a transport operation for a workpiece carrier in the process module, and/or wherein a lock or a reach-through tunnel is assigned to the coupling system.

6. The processing system according to claim 1, wherein the transport module comprises a first coupling part for a positive mechanical coupling with the process module and a first plug arrangement for an electrical coupling with the process module, and wherein the coupling system of the process module comprises a second coupling part for a positive mechanical coupling to the first coupling part and a second plug arrangement for an electrical coupling to the first plug arrangement.

7. The processing system according to claim 6, wherein each of the first plug arrangements is electrically connected to a manipulator or to a manipulator and a sensor device.

8. The processing system according to claim 1, wherein the process module comprises feet which can be adjusted in height in an automated manner, and comprises a position sensor and a control system, which are designed for an adjusting movement of the feet for automatically carrying out a coupling process with the respective coupling area and for an automatic spatial alignment of the process module with respect to the transport module.

9. The processing system according to claim 1, wherein the transport module comprises a base module on which two first transport path sections aligned parallel to one another are arranged, and wherein first coupling areas are arranged on mutually opposite end faces of the base module, respectively, each of which is designed for a connection to a further base module or to a deflection module.

10. The processing system according to claim 9, wherein the transport module comprises at least one deflection module with a second transport path section aligned transversely with respect to the first transport path sections, and wherein a second connecting region is assigned to a side surface of the deflection module for connection to the first connecting region of the base module.

11. The processing system according to claim 1, wherein a storage module is arranged at a coupling area of the transport module, which storage module comprises a plurality of conveyors from the group: belt conveyor, chain conveyor, wheel conveyor, magnetic conveyor, fluid conveyor, linear motor, which are controllable independently of one another, and wherein the storage module provides a temporary intermediate storage and/or a change of a sequence of workpiece carriers accommodated on the transport path.
